(19) United States
(12) Patent Application Publication
(10) Pub. No.: US 2023/0074218 A1
(43) Pub. Date: Mar. 9, 2023

(54) SORTATION-FRIENDLY CONTAINER AND METHOD

(71) Applicant: Berry Global, Inc., Evansville, IN (US)

(72) Inventors: Scott L. Fisher, Evansville, IN (US); Jordan French, Evansville, IN (US); Kristopher R. McWilliams, Lancaster, PA (US); Kelsey Coffey, Evansville, IN (US)

(21) Appl. No.: 17/896,441

(22) Filed: Aug. 26, 2022

Related U.S. Application Data
(60) Provisional application No. 63/237,785, filed on Aug. 27, 2021.

(51) Int. Cl. B65D 1/02; B07B 13/00; B07B 13/04

(52) U.S. Cl. CPC B65D 1/0261; B65D 1/023; B07B 13/003; B07B 13/04; B07B 2220/02

(57) ABSTRACT

A container includes a floor, a side wall arranged to extend upwardly from the floor, and a filler neck coupled to an upper end of the side wall and arranged to extend upwardly from the side wall. The container is sized to be reclaimed during a recycling process.

### PRIORITY CLAIM

This application claims priority under 35 U.S.C. § 119(e) to U.S. Provisional Application Ser. No. 63/237,785, filed Aug. 27, 2021, which is expressly incorporated by reference herein.

### BACKGROUND

The present disclosure relates to containers, and particularly to containers for storing liquids or other products. More particularly, the present disclosure relates to containers that may be reclaimed in a recycling process after being discarded.

### SUMMARY

According to the present disclosure, a container includes a floor, a side wall arranged to extend upwardly from the floor, and a filler neck coupled to an upper end of the side wall. In some embodiments, the container has an interior product-storage region with a volume within a range of about 50 milliliters to about 60 milliliters.

In illustrative embodiments, the container is sized to have an overall structure or profile that is greater than a predetermined, reclaim profile. The predetermined, reclaim profile is set by a sortation screen having a plurality of screen apertures. Each screen aperture provides the predetermined, reclaim profile and articles having a structure that is less than the predetermined, reclaim profile can pass through one of the screen apertures. Articles with an overall structure that is greater than the predetermined, reclaim profile, such as the container of the illustrative embodiment, are blocked from passing through the screen apertures and can be reclaimed for recycling.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a plurality of containers moving toward a sortation screen and showing that some of the containers are sized to be trapped in the sortation screen during a recycling process while others pass through one of a plurality of sortation apertures formed in the sortation screen;

FIG. 2 is a bottom view of a container trapped in a screen aperture due to the container being sized to have a predetermined, reclaim profile that blocks the container from passing through the screen aperture at all orientations relative to the sortation screen;

FIG. 3 is another bottom view of the container oriented differently relative to the screen aperture while still being blocked from passing through the screen aperture;

FIG. 4 is a perspective view of the container having the predetermined, reclaim profile;

FIG. 5 is a perspective view of a sortation tester with a plurality of the containers placed therein to determine a sortation score of the containers;

FIG. 6 is a perspective view of the sortation tester during a test in which the sortation tester is inverted so that containers, if any, will pass through the screen;

FIG. 7 is a flow chart of a process of forming and reclaiming the containers;

FIG. 8 is another flow chart of a process of forming, testing, and reclaiming the containers;

FIG. 9 is a perspective view of a second embodiment of a container having an overall structure greater than the predetermined, reclaim profile;

FIG. 10 is a bottom view of the second embodiment of the container;

FIG. 11 is a perspective view of a third embodiment of a container having an overall structure greater than the predetermined, reclaim profile;

FIG. 12 is a bottom view of the third embodiment of the container;

FIG. 13 is a perspective view of a fourth embodiment of a container having an overall structure greater than the predetermined, reclaim profile;

FIG. 14 is a bottom view of the fourth embodiment of the container;

FIG. 15 is a perspective view of a fifth embodiment of a container having an overall structure greater than the predetermined, reclaim profile;

FIG. 16 is a bottom view of the fifth embodiment of the container

FIG. 17 is a perspective view of a sixth embodiment of a container having an overall structure greater than the predetermined, reclaim profile;

FIG. 18 is a perspective view of a seventh embodiment of a container having an overall structure greater than the predetermined, reclaim profile;

FIG. 19 is a perspective view of an eighth embodiment of a container having an overall structure greater than the predetermined, reclaim profile;

FIG. 20 is a perspective view of a ninth embodiment of a container having an overall structure greater than the predetermined, reclaim profile;

FIG. 21 is a perspective view of a tenth embodiment of a container having an overall structure greater than the predetermined, reclaim profile;

FIG. 22 is a perspective view of an eleventh embodiment of a container having an overall structure greater than the predetermined, reclaim profile; and

FIG. 23 is a perspective view of a twelfth embodiment of a container having an overall structure greater than the predetermined, reclaim profile.

### DETAILED DESCRIPTION

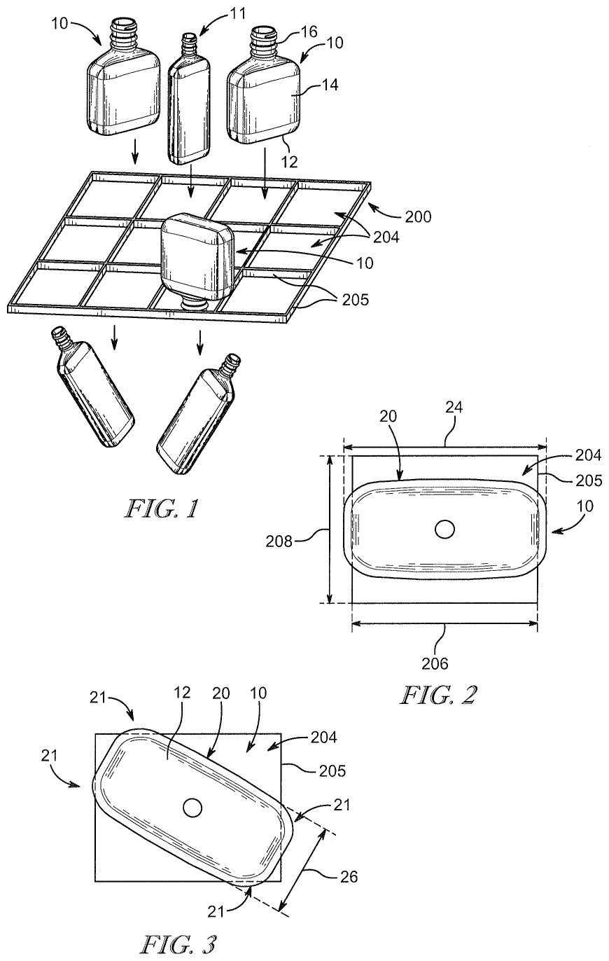

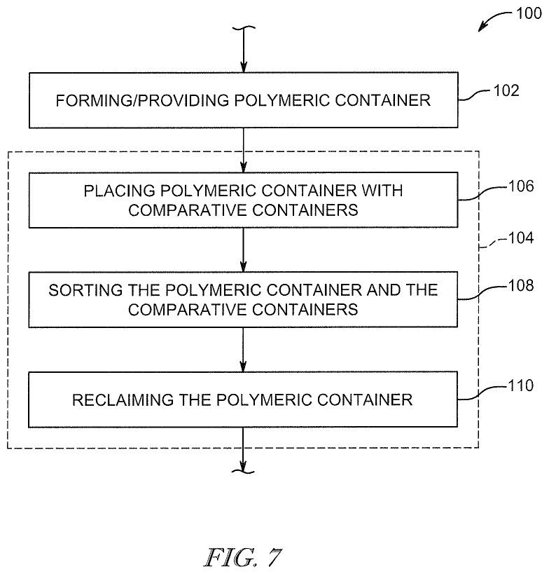

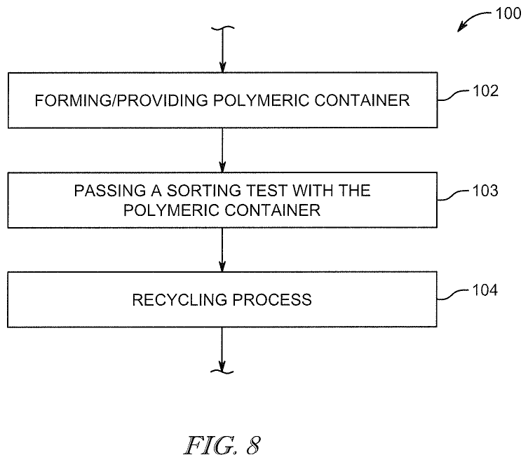

In accordance with the present disclosure, a container 10, shown in FIG. 1, is sized to be reclaimed during a recycling process 104 as shown in FIG. 7. During the recycling process 104 the container is advanced over a sortation screen 200. The sortation screen 200 includes a plurality of ribs 205 that define a plurality of screen apertures 204 each having a particular area and/or size to allow passage of articles not to be reclaimed during the recycling process 104. Articles having dimensions that provide an overall structure or profile greater than a predetermined, reclaim profile, such as container 10, are captured by the sortation screen 200 and then advanced downstream for further processing in the recycling process 104. Articles removed through one of the screen apertures 204 are separated from container(s) 10 and disposed of in a separate process.

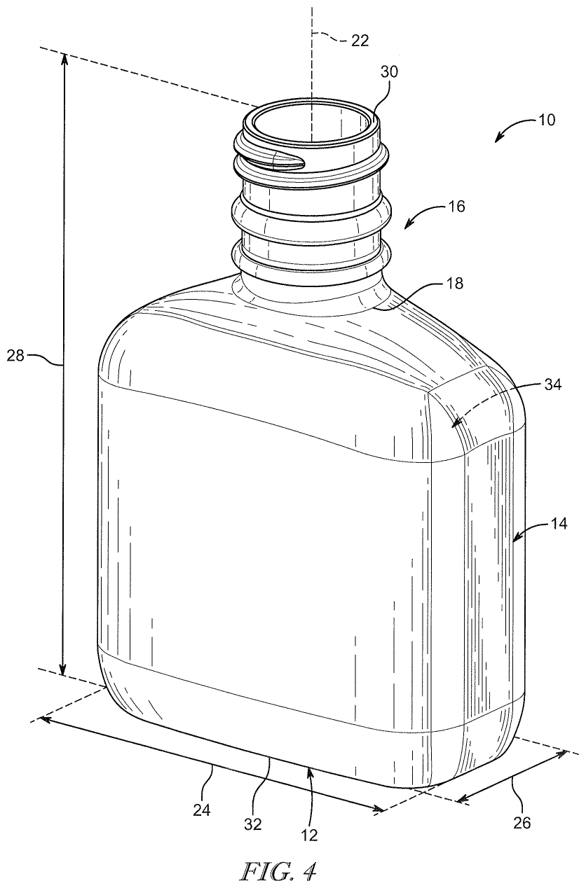

The container 10 is made from a polymeric material and includes a floor 12, a side wall 14 arranged to extend upwardly from the floor 12, and a filler neck 16 coupled to an upper end 18 of the side wall 14 and arranged to extend upwardly from the side wall 14 as shown in FIGS. 1 and 4. At least one of the floor 12 and the side wall 14 has a cross-sectional area 20 that is sized to block the container 10 from passing through the screen apertures 204 along a vertical axis 22 of the container 10.

The cross-sectional area 20 is defined by a length 24 and a width 26 of the container 10 as shown in FIGS. 2 and 3. Illustratively, the floor 12 and side wall 14 of the container 10 are formed into a generally rectangular cross-sectional shape having the length 24 and the width 26. In other embodiments, the floor 12 and/or side wall 14 of the container 10 may have a different cross-sectional shape such as oval, circular, triangular, square, or any other polygonal shape. Each corner 21 of the rectangular cross-sectional area 20 is rounded in the illustrative embodiment, however, in other embodiments the corners 21 may be pointed.

The container 10 further includes a height 28 that is sized to block the container 10 from passing through the screen apertures 204 in a direction perpendicular to the vertical axis 22. The height 28 extends from an upper end 30 of the filler neck 16 to a lower end 32 of the floor 12. Together the cross-sectional area 20, defined by length 24 and width 26, and the height 28 cooperate provide the container 10 with the overall profile. The overall profile is sized to maintain a predetermined volume while blocking the container 10 from passing all the way through any one of the screen apertures 204 at any orientation relative to the screen apertures 204 during the recycling process 104. The overall profile provides means for blocking the container 10 from passing all the way through any one of the screen apertures 204 at any orientation relative to the screen apertures 204 and for establishing a predetermined volume of the container 10.

The floor 12, the side wall 14, and the filler neck 16 define an interior product-receiving space 34 as shown in FIG. 4. In one example, the product-receiving space 34 has a predetermined volume within a range of about 45 milliliters to about 60 milliliters. In another example, the volume of the interior product-receiving space 34 is within a range of about 48 milliliters to about 58 milliliters. In another example, the volume of the interior product-receiving space 34 is within a range of about 50 milliliters to about 56 milliliters. In another example, the volume of the interior product-receiving space 34 is about 54 milliliters. In another example, the volume of the interior product-receiving space 34 is equal to about 54 milliliters so that the container 10 may be filled with about 50 milliliters of liquid product with a slight overhead volume in the filler neck 16. In another example, the volume of the interior product-receiving space 34 is equal to about 55 milliliters so that the container 10 may be filled with about 50 milliliters of liquid product with a slight overhead volume in the filler neck 16. In another example, the volume of the interior product-receiving space 34 is equal to about 56 milliliters so that the container 10 may be filled with about 50 milliliters of liquid product with a slight overhead volume in the filler neck 16. In another example, the volume of the interior product-receiving space 34 is equal to about 57 milliliters so that the container 10 may be filled with about 50 milliliters of liquid product with a slight overhead volume in the filler neck 16. The term about is used to account for slight manufacturing tolerances, and the volume may be within 2 milliliters of the stated value.

The container 10 is also formed to minimize weight (and thereby an amount of material) while maintaining a high top/compression load resistance so that the container 10 blocks deformation to a profile that is smaller than the predetermined, reclaim profile. In some embodiments, the container 10 has a weight within a range of about 10 grams to about 15 grams. In some embodiments, the container 10 has a weight within a range of about 11 grams to about 14 grams. In some embodiments, the container 10 has a weight within a range of about 11.1 grams to about 13.9 grams. In some embodiments, the container 10 has a weight within a range of about 11.2 grams to about 13.8 grams. In some embodiments, the container 10 has a weight within a range of about 11.3 grams to about 13.8 grams. In some embodiments, the container 10 has a weight within a range of about 11.4 grams to about 13.7 grams. In some embodiments, the container 10 has a weight within a range of about 11.5 grams to about 13.6 grams. In some embodiments, the container 10 has a weight within a range of about 11.5 grams to about 13.5 grams. In some embodiments, the container 10 has a weight within a range of about 11.5 grams to about 13.4 grams. In some embodiments, the container 10 has a weight within a range of about 11.5 grams to about 13.3 grams. In some embodiments, the container 10 has a weight within a range of about 11.5 grams to about 13.2 grams. In some embodiments, the container 10 has a weight within a range of about 11.6 grams to about 13.1 grams. In some embodiments, the container 10 has a weight within a range of about 11.7 grams to about 13 grams. In some embodiments, the container 10 has a weight within a range of about 11.8 grams to about 13 grams. In some embodiments, the container 10 has a weight within a range of about 11.9 grams to about 13 grams. In some embodiments, the container 10 has a weight of about 11.95 grams. In some embodiments, the container 10 has a weight of about 12.3 grams. In some embodiments, the container 10 has a weight of about 13.2 grams. In some embodiments, the container 10 has a weight of about 13.3 grams. In some embodiments, the container 10 has a weight of about 13.8 grams.

In some embodiments, the container 10 has a top load resistance greater than 100 lbf. In some embodiments, the container 10 has a top load resistance greater than 125 lbf. In some embodiments, the container 10 has a top load resistance greater than 190 lbf. In some embodiments, the container 10 has a top load resistance greater than 200 lbf. In some embodiments, the container 10 has a top load resistance within a range of about 180 lbf to about 230 lbf. In some embodiments, the container 10 has a top load resistance within a range of about 185 lbf to about 225 lbf. In some embodiments, the container 10 has a top load resistance within a range of about 190 lbf to about 220 lbf. In some embodiments, the container 10 has a top load resistance within a range of about 195 lbf to about 215 lbf. In some embodiments, the container 10 has a top load resistance within a range of about 200 lbf to about 210 lbf. In some embodiments, the container 10 has a top load resistance of about 205 lbf. In some embodiments, the container 10 has a top load resistance within a range of about 180 lbf to about 200 lbf. In some embodiments, the container 10 has a top load resistance within a range of about 185 lbf to about 200 lbf. In some embodiments, the container 10 has a top load resistance within a range of about 190 lbf to about 200 lbf. In some embodiments, the container 10 has a top load resistance of about 195 lbf. The term about is used to include values that are within 2 lbf of the stated value.

Comparative containers 11 are also shown in FIG. 1. In some embodiments, the comparative containers 11 have a height that is greater than height 28 of container 10. In some embodiments, the comparative containers 11 also have a length that is less than length 24 of container 10. In some embodiments, the comparative containers 11 also have a width that is less than width 26 of container 10. With these dimensions, the comparative containers 11 have the same volume as container 10, but are not trapped in screen 200 because their overall profile does not meet the predetermined, reclaim profile. Because of this, the comparative containers 11 can pass through on of the apertures 204 and will not be reclaimed during the recycling process 104 and, thus, may not be recycled.

The predetermined, reclaim profile is determined by the size of the screen apertures 204. In the illustrative embodiment each screen aperture 204 has a rectangular shape and has a length 206 equal to 1.97 inches (or about 2 inches) and a width 208 equal to 1.46 inches (or about 1.5 inches). In some embodiments, the length 206 and the width 208 may be slightly larger or smaller than the values indicated above. In one example, the length 206 and the width 208 are each within about 5 percent of the stated values. Thus, for an article to be reclaimed by screen 200, the article must have length, width, and height dimensions that block passage of the article through the screen apertures 204 from all orientations. The container 10 has length 24, width 26, and height 28 which provide the container 10 with an overall structure greater than the predetermined, reclaim profile such that passage of the container 10 through the screen apertures 204 is blocked from all orientations while the same volume of the comparative containers 11 is maintained. The comparative containers 11 do not have an overall structure or profile greater than the predetermined, reclaim profile and can pass through the screen 200 in at least one orientation relative to the screen 200.

Table 1 provides details about container 10 of the illustrative embodiment.

TABLE 1

| Length | Width | Height | Weight | Volume | Top Load |
|---|---|---|---|---|---|
| 2.065 in | 1 in | 2.95 in | 9.3 g | 57.43 ml | 206 lbf |

Table 2 provides details about comparative container 11.

TABLE 2

| Length | Width | Height | Volume | Top Load |
|---|---|---|---|---|
| 2 in | 0.9 in | 3.41 in | 54 ml | 274 lbf |

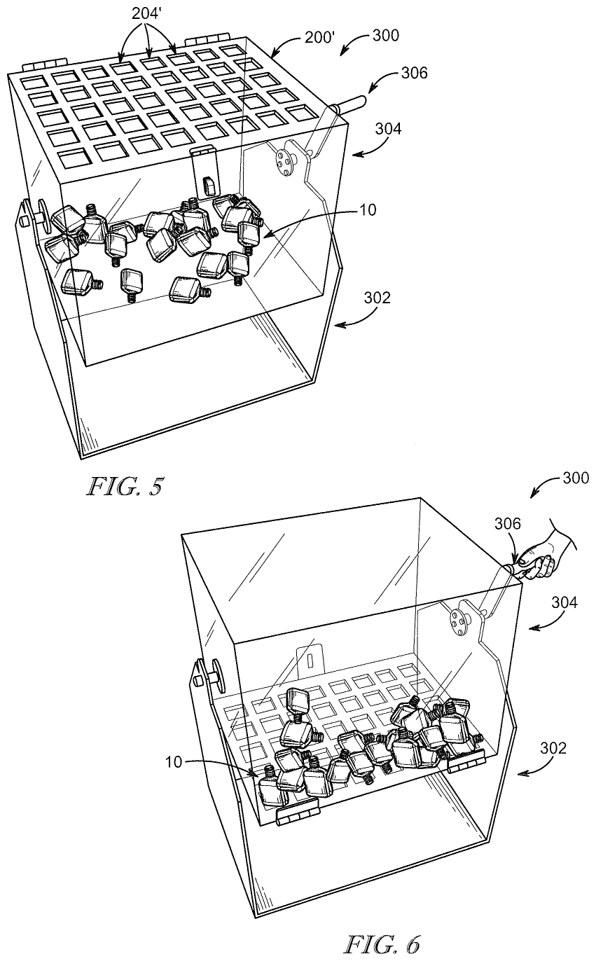

The container 10 and the comparative container 11 were each tested for sortation capabilities using a scaled sortation tester 300 as shown in FIGS. 5 and 6. The sortation tester includes a foundation 302, a rotary screen 304, and a rotation handle 306. The foundation 302 is placed on ground and supports the rotary screen 304 above ground. The rotary screen 304 includes a sortation screen 200′ that has screen apertures 204′ identical to screen apertures 204 used in the actual recycling process 104.

An operator placed 20 test containers 10, 11 inside the rotary screen 304. The rotation handle 306 was then used to rotate the rotary screen 304 relative to the foundation 302 at a rate of approximately 1¼ second per revolution, for 4½ revolutions (stopping so that the screen faced downward as shown in FIG. 6). The operator paused in this position for 3 seconds. The rotation handle 306 was then used to rotate the rotary screen 304 at the same rate for 5 more revolutions. At this point the number of test articles that passed through the screen 200′ were counted. The rotation steps were then repeated for a total of 30 iterations. In one example, the sortation test includes steps described by The Association of Plastic Recyclers on Document number Sort-B-02 titled “Evaluation of Size Sorting Potential for Articles with at least 2 Dimensions Less than 2 inches,” which is expressly incorporated by reference herein for the purpose of describing a suitable sortation test for testing container 10.

At the end of the test, the number of test containers 10, 11 left inside the rotary screen 304 were counted to determine the percent sorted. 100% of the test containers 10 were left inside the rotary screen. Only 10% of the comparative containers 11 were left in the rotary screen 304.

A process 100 of forming and reclaiming the container 10 is shown in FIG. 7. The process 100 includes forming or providing the container 10 having the predetermined, reclaim profile. The container 10 may be filled with product, used by a consumer, and discarded. After being discarded the container 10 may enter the recycling process 104. In the recycling process 104 the container may be placed with other comparative containers, such as container 11 at a step 106. All of the containers 10, 11 are then moved into a sorting machine including sorting screen 200 to be sorted at a step 108. During the step 108 of sorting, the comparative containers 11 pass through the screen apertures 204 while the containers 10 or the illustrative embodiment are blocked from passing through the screen apertures 204. Once sorted, the containers 10 are reclaimed at a step 110 and continue the recycling process 104.

The process 100 may include a step 103 of passing a sorting test. The sorting test includes using the sorting tester 300 discussed above. The sorting test also includes performing a compression test on each of the containers 10 prior to placing the containers in the rotary screen 304. The compression test is to simulate the containers being compressed in a typical recycling truck between when they were discarded and before reaching the recycling facility where the step of sorting 108 takes place. In the illustrative embodiment, the containers 10 are configured to maintain an overall profile greater than the predetermined, reclaim profile after being subjected to a compression force of about 10 psi (pounds per square inch). The compression force may occur on the side wall 14, or on any other part of the container 10 and is done with any caps removed from the container 10. In some embodiments, the container 10 has a high top load such that the container 10 does not compress to less than the predetermined, reclaim profile by a garbage/recycling truck, for example. In one example, the compression test includes steps described by The Association of Plastic Recyclers on Document number Sort-PR-01 titled “A Practice for Compressing Plastic Articles for Laboratory Evaluation,” which is expressly incorporated by reference herein for the purpose of describing a suitable compression test for testing container 10.

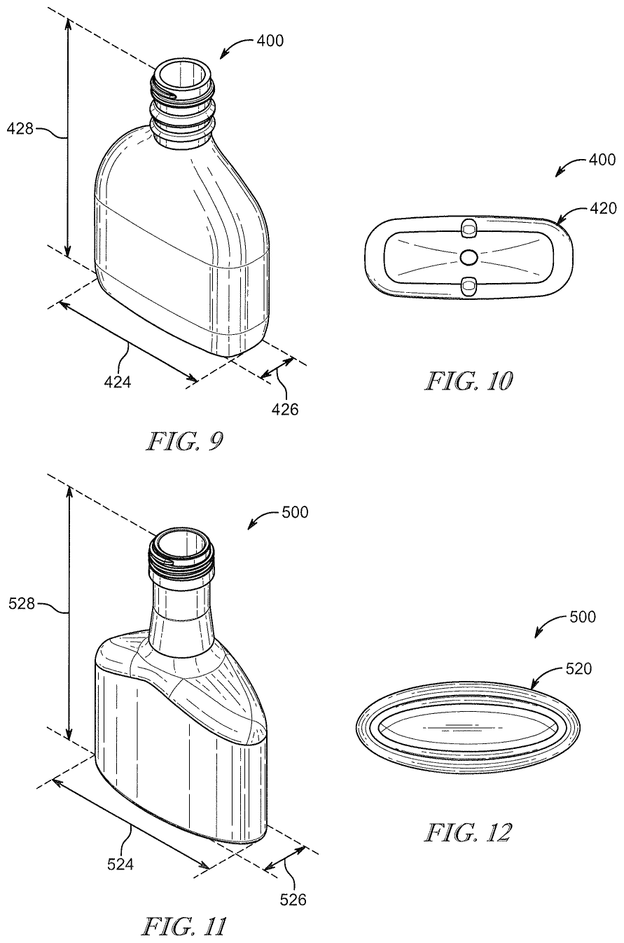

As discussed above, the container may have a different shape while still meeting the predetermined, reclaim profile and the volume as shown in FIGS. 9-16. Another embodiment of a container 400 having an overall structure greater than the predetermined, reclaim profile and the same internal volume as container 10 is shown in FIGS. 9 and 10. The container 400 has a length 424, width 426, and height 428 similar to length 24, width 26, and height 28 of container 10. The length 424 and width 426 of container 400 provide the container 400 with a cross-sectional area 420 with an oblong shape.

Table 3 provides details about container 400 of the illustrative embodiment.

TABLE 3

| Length | Width | Height | Weight | Volume |
|---|---|---|---|---|
| 2.25 in | 0.9 in | 3.165 in | 12.27 g | 54 ml |

Another embodiment of a container 500 having an overall structure greater than the predetermined, reclaim profile and the same internal volume as container 10 is shown in FIGS. 11 and 12. The container 500 has a length 524, width 526, and height 528 similar to length 24, width 26, and height 28 of container 10. The length 524 and width 526 of container 500 provide the container 500 with a cross-sectional area 520 with an oval shape. Container 500 also has a longer filler neck compared to container 10.

Table 4 provides details about container 500 of the illustrative embodiment.

TABLE 4

| Length | Width | Height | Weight | Volume |
|---|---|---|---|---|
| 2.425 in | 1 in | 3.411 in | 13.22 g | 54 ml |

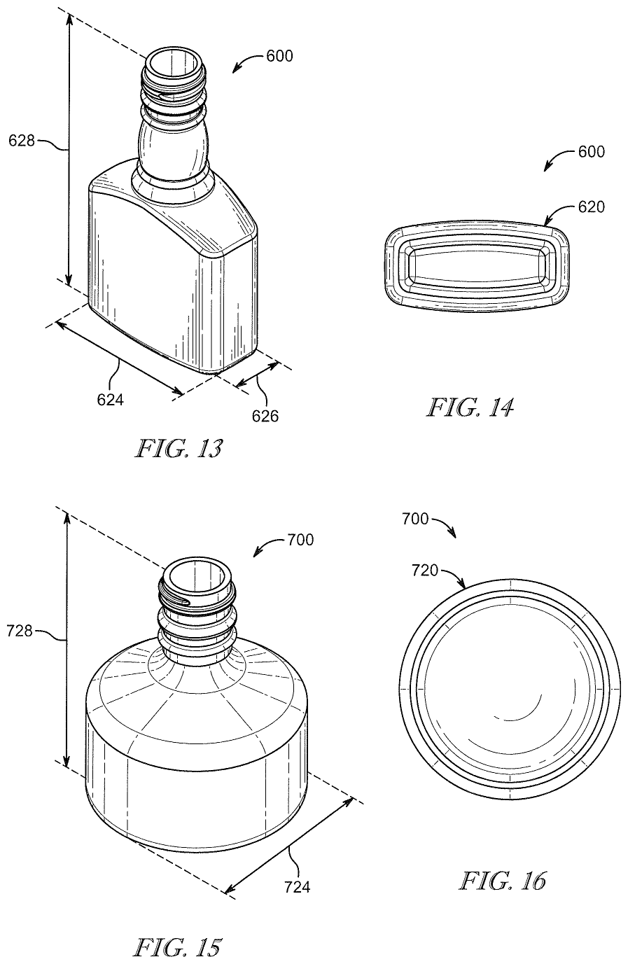

Another embodiment of a container 600 having an overall structure greater than the predetermined, reclaim profile and the same internal volume as container 10 is shown in FIGS. 13 and 14. The container 600 has a length 624, width 626, and height 628 similar to length 24, width 26, and height 28 of container 10. The length 624 and width 626 of container 600 provide the container 600 with a cross-sectional area 620 with an rectangular shape having more pointed corners than container 10. Container 600 also has a longer filler neck comparted to container 10.

Table 5 provides details about container 600 of the illustrative embodiment.

TABLE 5

| Length | Width | Height | Weight | Volume | Top Load |
|---|---|---|---|---|---|
| 2 in | 1 in | 3.54 in | 13.82 g | 54 ml | 128 lbf |

Another embodiment of a container 700 having an overall structure greater than the predetermined, reclaim profile and the same internal volume as container 10 is shown in FIGS. 15 and 16. The container 700 has a diameter 724 and height 728 similar to length 24 and height 28 of container 10. The diameter 724 of container 700 provides the container 700 with a cross-sectional area 720 with a circular shape. The container 700 is symmetrical about a vertical axis of the container 700 except for the threading on the filler neck of the container 700.

Table 6 provides details about container 700 of the illustrative embodiment.

TABLE 6

| Length | Width | Height | Weight | Volume | Top Load |
|---|---|---|---|---|---|
| 2 in | 2 in | 2.41 in | 13.32 g | 54 ml | 193 lbf |

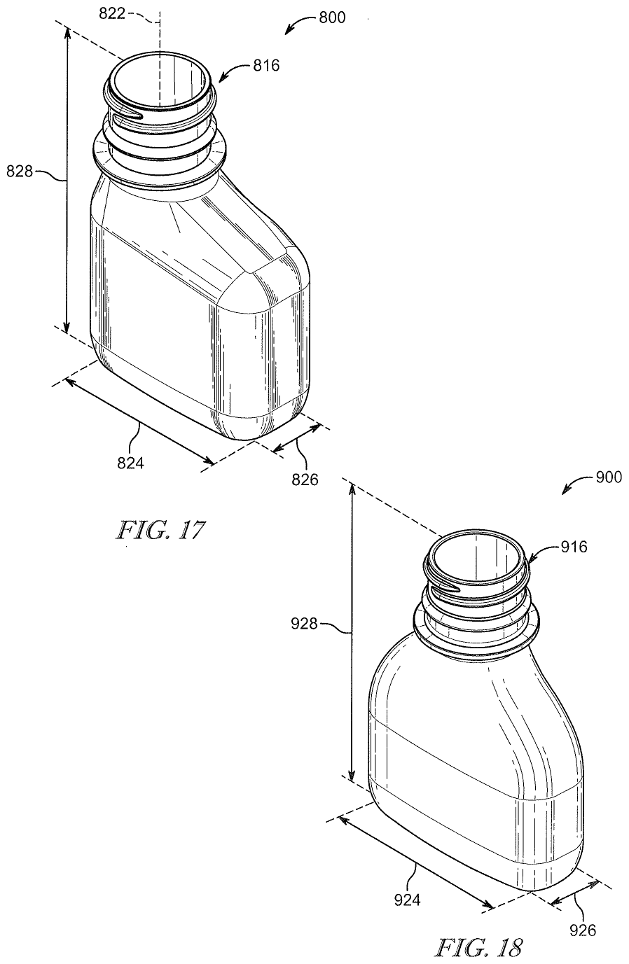

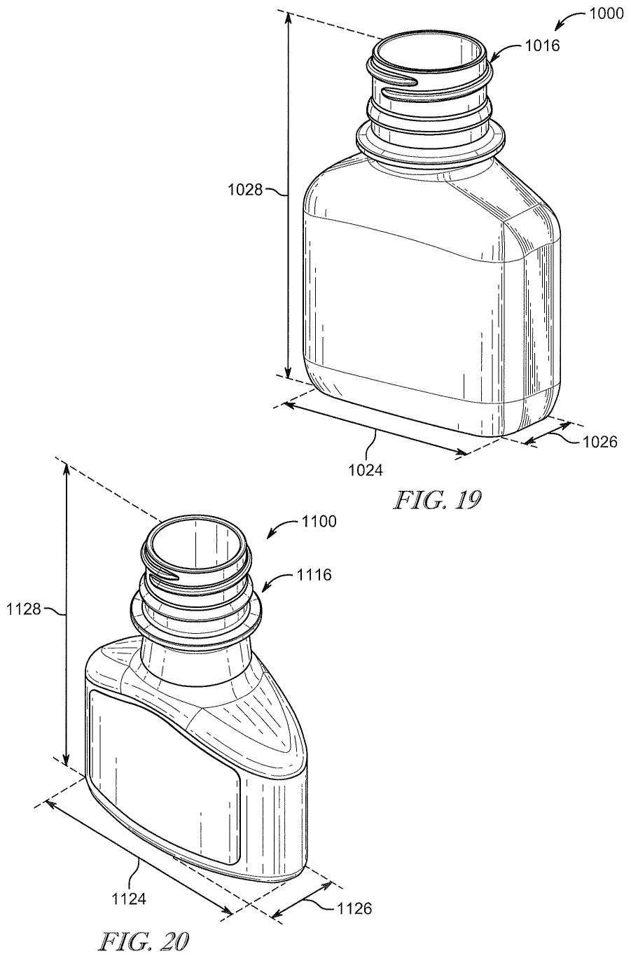

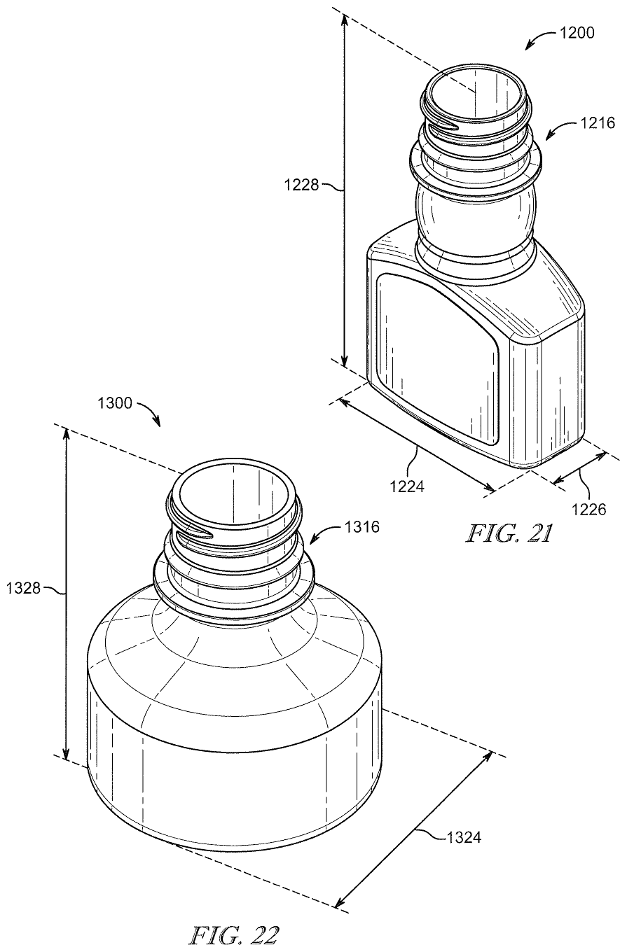

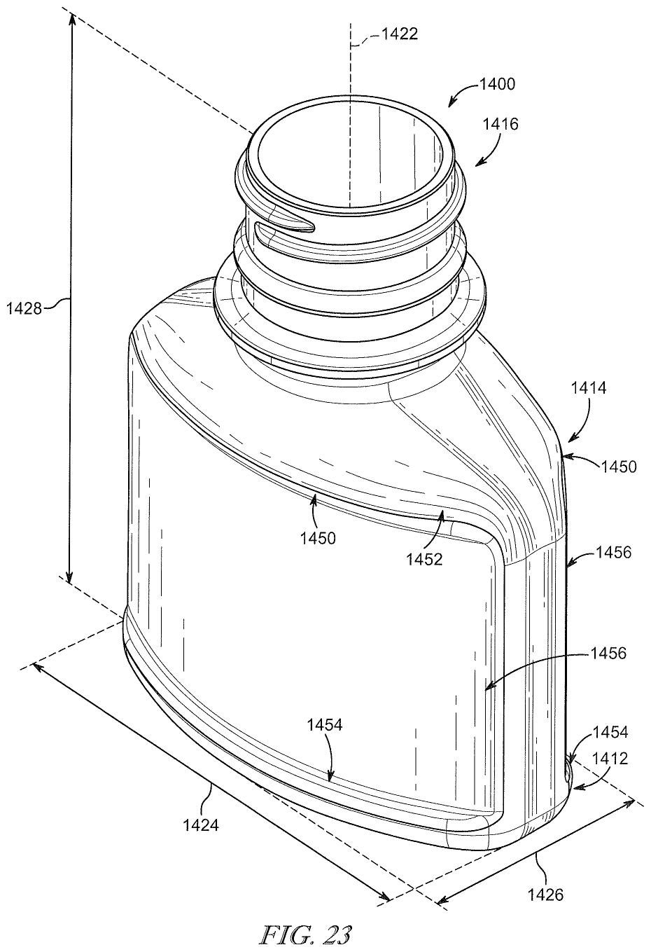

In some embodiments, the height of the container is variable if the length, width, or diameter of the filler neck is increased, as shown in FIGS. 17-23 for example, so long as the height remains above the greatest dimension of each screen aperture 204. In this way, the height of the container can vary while the interior volume of the container remains unchanged and the overall structure of the container exceeds the predetermined, reclaim profile such that passage of the container 10 through the screen apertures 204 is blocked from all orientations. In the illustrative embodiment, containers 10, 400, 500, 600, and 700 each have a filler neck having a diameter equal to about 18 millimeters. Containers 800, 900, 1000, 1100, 1200, 1300, 1400 each have filler necks 816, 916, 1016, 1116, 1216, 1316, 1416 having a diameter equal to about 24 millimeters. The larger diameter of the filler neck may increase a flow rate of liquid product from an interior of each container when the container is tilted when the product is being consumed, for example.

Other than the filler necks 816, 916, 1016, 1116, 1216, 1316, 1416 the other features or dimensions of the containers 800, 900, 1000, 1100, 1200, 1300, 1400 may be similar to one or more of containers 10, 400, 500, 600, and 700. For example, containers 800 and 1000 may have a length 824, 1024 and width 826, 1026, respectively, that is the same as length 24 and width 26 of container 10. Heights 828, 1028 are slightly smaller than height 28 to maintain an internal volume of 54 ml due to the added space provided by the increased diameter of filler necks 816, 1016. Filler neck 816 extends along an axis 822 that is offset to one lateral side of the container 800.

Container 900 may have length 924 and width 926 that is the same as length 424 and width 426 of container 400. Height 928 is slightly smaller than height 428 to maintain an internal volume of 54 ml due to the added space provided by the increased diameter of filler neck 916.

Container 1100 may have a length 1124 and width 1126 that is the same as length 524 and width 526. Height 1128 is slightly smaller than height 528 to maintain an internal volume of 54 ml due to the added space provided by the increased diameter of filler neck 1116.

Container 1200 may have a length 1224 and width 1226 that is the same as length 624 and width 626. Height 1228 is slightly smaller than height 628 to maintain an internal volume of 54 ml due to the added space provided by the increased diameter of filler neck 1216.

Container 1300 may have a width 1324 that is the same as width 524. Height 1328 is slightly smaller than height 728 to maintain an internal volume of 54 ml due to the added space provided by the increased diameter of filler neck 1316.

Container 1400 may have a length 1424 and width 1426 that is the same as length 24 and width 26. Height 1428 may be slightly smaller than height 28 to maintain an internal volume of 54 ml due to the added space provided by the increased diameter of filler neck 1416. Side wall 1414 of container 1400 is formed to include an upper side wall ridge 1450 formed near a shoulder 1452 of container 1400 and a lower side wall ridge 1454 formed near a floor 1412 of container 1400. Upper and lower side wall ridges 1450, 1454, shoulder 1452, and floor 1412 are at least partially spaced further from a central axis 1422 of filler neck 1416 than a panel 1456 positioned vertically between upper and lower ridges 1450, 1454. Illustratively, both front and rear faces of side wall 1414 include upper and lower ridges 1450, 1454 and a panel 1456 therebetween.

Additional examples of containers that have an overall profile greater than the predetermined, reclaim profile are described by the dimensions and properties shown in the Tables below.

TABLE 7

| Length | Width | Height | Weight | Volume |
|---|---|---|---|---|
| 2.25 in | 0.9 in | 3.039 in | 12.79 g | 54.5 ml |

TABLE 8

| Length | Width | Height | Weight | Volume |
|---|---|---|---|---|
| 2.005 in | 1 in | 2.824 in | 11.6 g | 54.6 ml |

TABLE 9

| Length | Width | Height | Weight | Volume |
|---|---|---|---|---|
| 2.425 in | 1.078 in | 2.933 in | 13.6 g | 54.6 ml |

TABLE 10

| Length | Width | Height | Weight | Volume |
|---|---|---|---|---|
| 2 in | 1 in | 3.278 in | 13 g | 54.5 ml |

TABLE 11

| Length | Width | Height | Weight | Volume |
|---|---|---|---|---|
| 2 in | 2 in | 2.339 in | 13.5 g | 54.55 ml |

TABLE 12

| Length | Width | Height | Weight | Volume |
|---|---|---|---|---|
| 2.15 in | 1.15 in | 2.864 in | 10.53 g | 55.84 ml |

TABLE 12

| Length | Width | Height | Weight | Volume |
|---|---|---|---|---|
| 2.15 in | 1.15 in | 2.704 in | 10.17 g | 55.77 ml |

The following numbered clauses include embodiments that are contemplated and non-limiting:

Clause 1. A container comprising a floor.

Clause 2. The container of clause 1, any other suitable clause, or any suitable combination of clauses, further comprising a side wall arranged to extend upwardly from the floor.

Clause 3. The container of clause 2, any other suitable clause, or any suitable combination of clauses, further comprising a filler neck coupled to an upper end of the side wall and arranged to extend upwardly from the side wall.

Clause 4. The container of clause 3, any other suitable clause, or any suitable combination of clauses, wherein the floor, the side wall, and the filler neck define an interior product-receiving space.

Clause 5. The container of clause 4, any other suitable clause, or any suitable combination of clauses, wherein the interior product-receiving space has a volume within a range of about 50 milliliters to about 60 milliliters, and

Clause 6. The container of clause 5, any other suitable clause, or any suitable combination of clauses, wherein the container has an overall profile that is greater than a predetermined, reclaim profile.

Clause 7. The container of clause 6, any other suitable clause, or any suitable combination of clauses, wherein the predetermined, reclaim profile is defined by a rectangular aperture having a length less than or equal to about 2 inches and a width equal to about 1.5 inches.

Clause 8. The container of clause 7, any other suitable clause, or any suitable combination of clauses, wherein the container cannot pass through the rectangular aperture at any orientation.

Clause 9. The container of clause 8, any other suitable clause, or any suitable combination of clauses, wherein the overall profile is provided by a height of the container, a length of the container, and a width of the container, and wherein at least two of the height, the length, and the width are greater than or equal to 2 inches.

Clause 10. The container of clause 9, any other suitable clause, or any suitable combination of clauses, wherein the at least one of the height, the length, and the width is less than or equal to 2 inches.

Clause 11. The container of clause 10, any other suitable clause, or any suitable combination of clauses, wherein at least one of the height, the length, and the width is less than 1.5 inches.

Clause 12. The container of clause 11, any other suitable clause, or any suitable combination of clauses, wherein the height is about 3 inches, the length is about 2 inches, and the width is about 1 inch.

Clause 13. The container of clause 9, any other suitable clause, or any suitable combination of clauses, wherein the height is defined between a bottom of the floor to a top of the filler neck, the length is defined between a first side of the side wall to an opposite second side of the side wall, and the width is defined between a front of the side wall and a back of the side wall, and wherein the height and the length are both greater than or equal to 2 inches and the width is less than 2 inches.

Clause 14. The container of clause 13, any other suitable clause, or any suitable combination of clauses, wherein the height is about 3 inches, the length is about 2 inches, and the width is about 1 inch.

Clause 15. The container of clause 14, any other suitable clause, or any suitable combination of clauses, wherein the volume is about 54 milliliters.

Clause 16. A container comprising a floor, a side wall arranged to extend upwardly from the floor, and a filler neck coupled to an upper end of the side wall and arranged to extend upwardly from the side wall.

Clause 17. The container of clause 16, any other suitable clause, or any suitable combination of clauses, wherein the floor, the side wall, and the filler neck define an interior product-receiving space having a volume within a range of about 50 milliliters to about 60 milliliters.

Clause 18. The container of clause 17, any other suitable clause, or any suitable combination of clauses, wherein a height of the container is defined between a bottom of the floor to a top of the filler neck, a length of the container is defined between a first side of the side wall to an opposite second side of the side wall, and a width of the container is defined between a front of the side wall and a back of the side wall.

Clause 19. The container of clause 18, any other suitable clause, or any suitable combination of clauses, wherein at least two of the height, the length, and the width are greater than or equal to 2 inches.

Clause 20. The container of clause 19, any other suitable clause, or any suitable combination of clauses, wherein the container has an overall profile that is greater than a predetermined, reclaim profile defined by a rectangular aperture having a length equal to 1.97 inches and a width equal to 1.46 inches such that the container cannot pass through the rectangular aperture at any orientation.

Clause 21. The container of clause 19, any other suitable clause, or any suitable combination of clauses, wherein the height is about 3 inches, the length is about 2 inches, and the width is about 1 inch.

Clause 22. The container of clause 20, any other suitable clause, or any suitable combination of clauses, wherein the at least one of the height, the length, and the width is less than or equal to 2 inches.

Clause 23. The container of clause 22, any other suitable clause, or any suitable combination of clauses, wherein at least one of the height, the length, and the width is less than 1.5 inches.

Clause 24. The container of clause 19, any other suitable clause, or any suitable combination of clauses, wherein the container has a top load greater than 190 lbf to block the container from compressing to less than the predetermined, reclaim profile.

Clause 25. A method of obtaining reclaimed polymeric containers during a recycling process.

Clause 26. The method of clause 25, any other suitable clause, or any suitable combination of clauses, the method comprising forming a polymeric container.

Clause 27. The method of clause 26, any other suitable clause, or any suitable combination of clauses, the container including a floor, a side wall arranged to extend upwardly from the floor, and a neck coupled to an upper end of the side wall and arranged to extend upwardly from the side wall, wherein the floor, the side wall, and the neck define an interior product-receiving space having a volume within a range of about 50 milliliters to about 60 milliliters.

Clause 28. The method of clause 27, any other suitable clause, or any suitable combination of clauses, the method includes placing the polymeric container together with comparative containers.

Clause 29. The method of clause 28, any other suitable clause, or any suitable combination of clauses, the method includes sorting the polymeric container from the comparative containers by exposing the polymeric container to a sortation screen having a plurality of screen apertures, each screen aperture having a rectangular shape with a length equal to about 2 inches and a width equal to about 1.5 inches, wherein the comparative containers pass through one of the plurality of screen apertures and the polymeric container is blocked from passing through the screen apertures.

Clause 30. The method of clause 29, any other suitable clause, or any suitable combination of clauses, the method includes reclaiming the polymeric container.

Clause 31. The method of clause 30, any other suitable clause, or any suitable combination of clauses, wherein the container has an overall profile that is greater than a predetermined, reclaim profile defined by each screen aperture, each screen aperture having a length equal to 1.97 inches and a width equal to 1.46 inches such that the container cannot pass through each screen aperture at any orientation relative to the screen aperture.

Clause 32. The method of clause 31, any other suitable clause, or any suitable combination of clauses, wherein a height of the container is defined between a bottom of the floor to a top of the filler neck, a length of the container is defined between a first side of the side wall to an opposite second side of the side wall, and a width of the container is defined between a front of the side wall and a back of the side wall.

Clause 33. The method of clause 32, any other suitable clause, or any suitable combination of clauses, wherein the at least one of the height, the length, and the width is less than or equal to 2 inches.

Clause 34. The method of clause 33, any other suitable clause, or any suitable combination of clauses, wherein the height is about 3 inches, the length is about 2 inches, and the width is about 1 inch.

Clause 35. The method of clause 28, any other suitable clause, or any suitable combination of clauses, further comprising a step of applying a force to the polymeric container and the comparative, and wherein the polymeric container continues to have a profile that is larger than the predetermined, reclaim profile after being exposed to the force.

Clause 36. The method of clause 28, any other suitable clause, or any suitable combination of clauses, wherein the volume is about 55 milliliters.

1. A container comprising
a floor,
a side wall arranged to extend upwardly from the floor, and
a filler neck coupled to an upper end of the side wall and arranged to extend upwardly from the side wall,
wherein the floor, the side wall, and the filler neck define an interior product-receiving space having a volume within a range of about 50 milliliters to about 60 milliliters, and
wherein the container has an overall profile that is greater than a predetermined, reclaim profile defined by a rectangular aperture having a length less than or equal to about 2 inches and a width equal to about 1.5 inches such that the container cannot pass through the rectangular aperture at any orientation.

2. The container of claim 1, wherein the overall profile is provided by a height of the container, a length of the container, and a width of the container, and wherein at least two of the height, the length, and the width are greater than or equal to 2 inches.

3. The container of claim 2, wherein the at least one of the height, the length, and the width is less than or equal to 2 inches.

4. The container of claim 3, wherein at least one of the height, the length, and the width is less than 1.5 inches.

5. The container of claim 4, wherein the height is about 3 inches, the length is about 2 inches, and the width is about 1 inch.

6. The container of claim 2, wherein the height is defined between a bottom of the floor to a top of the filler neck, the length is defined between a first side of the side wall to an opposite second side of the side wall, and the width is defined between a front of the side wall and a back of the side wall, and wherein the height and the length are both greater than or equal to 2 inches and the width is less than 2 inches.

7. The container of claim 6, wherein the height is about 3 inches, the length is about 2 inches, and the width is about 1 inch.

8. The container of claim 7, wherein the volume is about 54 milliliters.

9. A container comprising
a floor,
a side wall arranged to extend upwardly from the floor, and
a filler neck coupled to an upper end of the side wall and arranged to extend upwardly from the side wall,
wherein the floor, the side wall, and the filler neck define an interior product-receiving space having a volume within a range of about 50 milliliters to about 60 milliliters,
wherein a height of the container is defined between a bottom of the floor to a top of the filler neck, a length of the container is defined between a first side of the side wall to an opposite second side of the side wall, and a width of the container is defined between a front of the side wall and a back of the side wall, and
wherein at least two of the height, the length, and the width are greater than or equal to 2 inches.

10. The container of claim 9, wherein the container has an overall profile that is greater than a predetermined, reclaim profile defined by a rectangular aperture having a length equal to 1.97 inches and a width equal to 1.46 inches such that the container cannot pass through the rectangular aperture at any orientation.

11. The container of claim 9, wherein the height is about 3 inches, the length is about 2 inches, and the width is about 1 inch.

12. The container of claim 9, wherein the at least one of the height, the length, and the width is less than or equal to 2 inches.

13. The container of claim 12, wherein at least one of the height, the length, and the width is less than 1.5 inches.

14. The container of claim 9, wherein the container is configured to maintain an overall profile greater than the predetermined, reclaim profile after being subjected to a compression force of at least 10 psi.

15. A method of obtaining reclaimed polymeric containers during a recycling process, the method comprising
forming a polymeric container, the container including a floor, a side wall arranged to extend upwardly from the floor, and a neck coupled to an upper end of the side wall and arranged to extend upwardly from the side wall, wherein the floor, the side wall, and the neck define an interior product-receiving space having a volume within a range of about 50 milliliters to about 60 milliliters,
placing the polymeric container together with comparative containers;
sorting the polymeric container from the comparative containers by exposing the polymeric container to a sortation screen having a plurality of screen apertures, each screen aperture having a rectangular shape with a length equal to about 2 inches and a width equal to about 1.5 inches, wherein the comparative containers pass through one of the plurality of screen apertures and the polymeric container is blocked from passing through the screen apertures, and
reclaiming the polymeric container.

16. The method of claim 15, wherein the container has an overall profile that is greater than a predetermined, reclaim profile defined by each screen aperture, each screen aperture having a length equal to 1.97 inches and a width equal to 1.46 inches such that the container cannot pass through each screen aperture at any orientation relative to the screen aperture.

17. The container of claim 16, wherein a height of the container is defined between a bottom of the floor to a top of the filler neck, a length of the container is defined between a first side of the side wall to an opposite second side of the side wall, and a width of the container is defined between a front of the side wall and a back of the side wall, and wherein the at least one of the height, the length, and the width is less than or equal to 2 inches.

18. The container of claim 17, wherein the height is about 3 inches, the length is about 2 inches, and the width is about 1 inch.

19. The container of claim 13, further comprising a step of applying a force to the polymeric container and the comparative, and wherein the polymeric container continues to have a profile that is larger than the predetermined, reclaim profile after being exposed to the force.

20. The container of claim 13, wherein the volume is about 55 milliliters.
